(19) United States
(12) Patent Application Publication
(10) Pub. No.: US 2020/0001139 A1
(43) Pub. Date: Jan. 2, 2020

(54) GOLF BALL

(71) Applicant: Bridgestone Sports Co., Ltd., Tokyo (JP)

(72) Inventors: Hirotaka Shinohara, Chichibushi (JP); Kae Iizuka, Chichibushi (JP); Atsushi Namba, Chichibushi (JP)

(73) Assignee: Bridgestone Sports Co., Ltd., Tokyo (JP)

(21) Appl. No.: 16/444,509

(22) Filed: Jun. 18, 2019

(30) Foreign Application Priority Data
Jun. 29, 2018 (JP) 2018-124373

(51) Int. Cl. A63B 37/00; C08L 23/08; C09D 175/04; C09D 7/42

(52) U.S. Cl. CPC A63B 37/0022; A63B 37/0096; C08L 23/0876; C08K 3/36; C09D 7/42; A63B 37/0075; A63B 37/0076; C09D 175/04

(57) ABSTRACT

A golf ball having a core of at least one layer is provided on the ball surface with a delustering particle-containing coating layer having an average surface roughness Ra of between 0.5 and 1.0. The golf ball is a matte ball that is free of luster and gloss and moreover can prevent a reduction in the ball spin rate on approach shots.

### CROSS-REFERENCE TO RELATED APPLICATION

This non-provisional application claims priority under 35 U.S.C. § 119(a) on Patent Application No. 2018-124373 filed in Japan on Jun. 29, 2018, the entire contents of which are hereby incorporated by reference.

### TECHNICAL FIELD

The present invention relates to a golf ball having a core of at least one layer and a coating layer. More specifically, the invention relates to a golf ball which has a matte, gloss-free appearance and includes a coating layer with a suitable surface roughness.

### BACKGROUND ART

The dimples formed on the surface of a golf ball are known to be an important constituent element that increases the aerodynamic performance of the ball during its flight. Also, JP-A 2015-142599, JP-A 2015-142600 and JP-A 2016-214326 describe suitably adjusting the surface roughness of a paint film (coating layer) in order to optimize the relationship between the coefficient of drag CD and the coefficient of lift CL when a golf ball is hit at a specific Reynolds number and spin rate, and thereby increase the distance traveled by the ball. In such cases, steps for adjusting the surface roughness of the paint film are needed in the golf ball production process, adding to the difficulty and cost.

JP-A 2014-520650 discloses that, by including a resin and a plurality of particles of a specific average particle size in a coating layer applied onto the outside surface of the golf ball proper and thereby finely adjusting the surface roughness of the ball, the ball can achieve the desired aerodynamic performance. However, in this golf ball, when the surface roughness is high, the surface area of contact between the ball and the clubface at the time of impact decreases, which may lower the spin rate on approach shots.

In addition, so-called matte golf balls which have an appearance that is colored but are delustered or free of gloss to such a degree that dimple contours on the surface of the ball cannot be discerned have been popular recently. Such matte golf balls are colored golf balls which have a novel coloration and, although the dimples are not clearly visible, the balls reportedly have a psychological effect that increases the player's concentration on the ball when hitting the ball on shots with a driver and on approach shots, thereby increasing the golf competitiveness.

However, such matte golf balls include a delusterant such as silica primarily in a urethane or other resin making up the paint film, and the ball surface is formed so as to be relatively rough. Such golf balls lower the surface area of contact between the ball and the clubface at the time of impact, as a result of which the spin rate on approach shots may decrease.

### SUMMARY OF THE INVENTION

It is therefore an object of the present invention to provide a matte golf ball which is free of luster and gloss and which is able to prevent a reduction in the ball spin rate on approach shots.

As a result of extensive investigations, we have discovered that, in a golf ball having a core of at least one layer, by forming on the ball surface a coating layer that contains delustering particles and by adjusting the average surface roughness Ra of this coating layer to between 0.5 and 1.0, the ball surface acquires a matte finish which enables the player to improve his or her concentration on the ball at the time of ball impact and which also is able to prevent a reduction in the spin performance on approach shots.

Accordingly, the present invention provides a golf ball having a core of at least one layer, wherein the golf ball has on a surface thereof a delustering particle-containing coating layer. The coating layer has an average surface roughness Ra of between 0.5 and 1.0.

The delustering particles preferably have a BET specific surface area of from 200 to 400 m²/g.

The delustering particles preferably have an average primary particle size of from 1.0 to 3.0 μm.

The content of delustering particles per 100 parts by weight of the coating layer base resin (combined amount of resin ingredients and solvent) is preferably from 5 to 10 parts by weight.

The coating layer has a reflectance as measured with a glossmeter of preferably 5.0 or less at an angle of incidence of 20°, 20.0 or less at an angle of incidence of 60° and 40.0 or less at an angle of incidence of 85°.

### ADVANTAGEOUS EFFECTS OF THE INVENTION

In the golf ball of the invention, by giving the ball a matte finish, it is possible to prevent both a decrease in competitiveness due to diminished player concentration and a reduction in the spin performance of the ball on approach shots.

### DESCRIPTION OF THE PREFERRED EMBODIMENTS

The objects, features and advantages of the invention will become more apparent from the following detailed description.

The golf ball of the invention has a core of at least one layer, and has on the ball surface a coating layer that contains delustering particles.

The core may be formed using a known rubber material as the base material. Known base rubbers, such as natural rubber or synthetic rubber, may be used as the base rubber. More specifically, the use of polybutadiene, especially cis-1,4-polybutadiene having a cis structure content of at least 40%, is recommended. If desired, natural rubber, polyisoprene rubber, styrene-butadiene rubber and the like may be used together with the foregoing polybutadiene in the base rubber. The polybutadiene may be synthesized with, for example, a titanium-based, cobalt-based, nickel-based or neodymium-based Ziegler-type catalyst or with a cobalt, nickel or other metal catalyst.

Co-crosslinking agents such as unsaturated carboxylic acids and metal salts thereof, inorganic fillers such as zinc oxide, barium sulfate and calcium carbonate, and organic peroxides such as dicumyl peroxide and 1,1-bis(t-butylperoxy)cyclohexane may be included in the base rubber. If necessary, commercial antioxidants and the like may also be suitably added.

A cover of at least one layer may be formed over the core as a core-encasing member. In the case of a two-layer cover, the inner layer is called the intermediate layer and the outer layer is called the outermost layer. In the case of a three-layer cover, the respective layers are called, in order from the inner side: the envelope layer, the intermediate layer and the outermost layer.

Examples of the materials making up the respective cover layers include, without particular limitation, resins that have hitherto been used as golf ball materials, such as ionomeric resins, polyester resins, polyurethane resins, polyamide resins, polyolefin resins, olefin-based thermoplastic elastomers and styrene-based thermoplastic elastomers. lonomeric resins are especially suitable. Preferred ionomeric resins are ones which include either (a) or (b) below:
(a) an ethylene-α,β-unsaturated carboxylic acid copolymer and/or a metal salt thereof,
(b) an ethylene-α,β-unsaturated carboxylic acid-α,β-unsaturated carboxylic acid ester copolymer and/or a metal salt thereof.

Specific examples of the α,β-unsaturated carboxylic acid in components (a) and (b) include acrylic acid, methacrylic acid, maleic acid and fumaric acid. Acrylic acid and methacrylic acid are especially preferred. The α,β-unsaturated carboxylic acid ester in component (b) is preferably a lower alkyl ester of the above unsaturated carboxylic acid, specific examples of which include methyl methacrylate, ethyl methacrylate, propyl methacrylate, butyl methacrylate, methyl acrylate, ethyl acrylate, propyl acrylate and butyl acrylate. Butyl acrylate (butyl n-acrylate, butyl i-acrylate) is especially preferred.

Metal ion neutralization products of the copolymers in components (a) and (b) can be obtained by partially neutralizing acid groups on the olefin-unsaturated carboxylic acid copolymer or the olefin-unsaturated carboxylic acid-unsaturated carboxylic acid ester copolymer with metal ions. Illustrative examples of metal ions which neutralize the acid groups include Na⁺, K⁺, Li⁺, Zn⁺⁺, Cu⁺⁺, Mg⁺⁺, Ca⁺⁺, Co⁺⁺, Ni⁺⁺ and Pb⁺⁺. Preferred use can be made of Na⁺, Li⁺, Zn⁺⁺, Mg⁺⁺ and Ca⁺⁺ in particular. Such neutralization products may be obtained by a known method. For example, a neutralization product may be obtained by using, for reaction with the above copolymer, a compound such as a formate, acetate, nitrate, carbonate, bicarbonate, oxide, hydroxide or alkoxide of the above metal ion.

Known substances may be used as components (a) and (b). Illustrative examples include commercial products such as the following acid copolymers: Nucrel® N1560, Nucrel® N1214, Nucrel® N1035, Nucrel® AN4221C, Nucrel® AN4311, Nucrel® AN4318 and Nucrel® AN4319 (all products of DuPont-Mitsui Polychemicals Co., Ltd.). Illustrative examples of metal ion neutralization products of acid copolymers include Himilan® 1554, Himilan® 1557, Himilan® 1601, Himilan® 1605, Himilan® 1706, Himilan® AM7311, Himilan® 1855, Himilan® 1856 and Himilan® AM7316 (all products of DuPont-Mitsui Polychemicals Co., Ltd.), and Surlyn® 7930, Surlyn® 6320, Surlyn® 8320, Surlyn® 9320 and Surlyn® 8120 (E.I. DuPont de Nemours and Company).

The resin material for the outermost layer of the cover may include a colorant comprising a fluorescent dye or fluorescent pigment and a white pigment such as titanium oxide. That is, in order to finish the ball to a colored ball whose surface is free of luster and soft-toned, a colorant comprising a fluorescent dye or fluorescent pigment may be included in the outermost layer-forming resin material. Color is imparted to the outermost layer of the cover by suitably including a known fluorescent dye or fluorescent pigment as the colorant. Examples include solvent yellow, solvent orange, anthraquinone and phthalocyanine (all of which are dyes), and also yellow fluorescent pigments, pink fluorescent pigments and orange fluorescent pigments. Known commercial products may be used as these colorants.

In cases where such a colorant is used, it is preferable to employ a fluorescent colorant that is light harvesting. Light-harvesting fluorescent colorants are materials which have the ability to collect sunlight and convert the wavelength to the long-wavelength side as fluorescent light. These materials are characterized in that they collect light by totally reflecting it at the interior of the colored material and guiding it to the dimple edges, where the light is emitted in a concentrated state and intensely colored.

Such light-harvesting fluorescent colorants include systems that generate orange, pink, red, yellow, blue or violet colors. Commercial products may be used in any of these chromogenic systems. Examples of light-harvesting fluorescent dyes that may be used include those available from BASF under the trade names Lumogen F Yellow 083, Lumogen F Orange 240, Lumogen F Red 305 and Lumogen F Blue 650, and those available from Kashinomoto Technologies Co., Ltd. under the trade names Lumicolor Red, Smart Color LP Green, Smart Color LP Yellow and Smart Color LP Orange.

The amount of the above colorant included per 100 parts by weight of the outermost layer-forming resin material is from 0.001 to 0.2 part by weight, and preferably from 0.005 to 0.1 part by weight. When this amount is low, the fluorescence may weaken and the desired decorativeness may not be obtained. On the other hand, when this amount is high, migration of the colorants, especially dyes, may arise, staining objects that come into contact with the golf ball.

The white pigment is exemplified by titanium oxide, zinc oxide and barium sulfate. Preferred use can be made of titanium oxide. When a white pigment such as titanium oxide is used, the amount included per 100 parts by weight of the outermost layer-forming resin material is from 1.0 to 10.0 parts by weight, and preferably from 2.0 to 5.0 parts by weight.

An inorganic filler or organic filler may be included in the outermost layer-forming resin material. When an inorganic filler is used, examples of such materials include, without particular limitation, calcium carbonate and silica.

When an organic filler is used, examples of such materials include, without particular limitation, fine particles of crosslinked polymethyl methacrylate (crosslinked PMMA), crosslinked polybutyl methacrylate, crosslinked polyacrylate ester, crosslinked acrylic-styrene copolymer, melamine resin or polyurethane.

The amount of the inorganic filler or organic filler added per 100 parts by weight of the above resin material is from 0.01 to 1.0 part by weight, and preferably from 0.02 to 0.2 part by weight. When too much is added, the hiding properties may become excessive, detracting from a ball design having a quality feel, or the change in color when color fading occurs due to sunlight exposure may increase.

In addition, various additives may be optionally included in the resin composition.

For example, pigments, dispersants, antioxidants, light stabilizers, ultraviolet absorbers and lubricants may be suitably added.

The resin composition can be obtained by mixing together the above ingredients using, for example, any of various types of mixers, such as a kneading-type single-screw or twin-screw extruder, a Banbury mixer or a kneader.

Numerous dimples of one, two or more types may be formed on the surface of the outermost layer. The shapes, diameters, depths, number, surface occupancy and other characteristics of the dimples may be suitably selected.

The golf ball of the invention has a coating layer (paint film), which coating layer is formed using a paint composition that contains delustering particles.

The paint composition is not particularly limited, although it is preferable to use a urethane-based paint. Because the paint film must be capable of enduring the harsh conditions of golf ball use, a two-part curable urethane paint, especially a non-yellowing urethane paint, is preferred.

In the case of a two-part curable urethane paint, various polyols such as saturated polyester polyols, acrylic polyols or polycarbonate polyols may be used as the base resin, and non-yellowing polyisocyanates such as adducts, biurets or isocyanurates of hexamethylene diisocyanate, isophorone diisocyanate or hydrogenated xylylene diisocyanate, or mixtures thereof, may be used as the isocyanate.

Exemplary delustering particles include silica particles, melamine particles and acrylic particles. Specific examples include silica, polymethyl methacrylate, polybutyl methacrylate, polystyrene and polybutyl acrylate. The delustering particles may be organic particles or inorganic particles, with the use of silica particles being especially preferred.

From the standpoint of their light quenching properties and coating properties, the delustering particles have a specific surface area, expressed as the BET specific surface area, of preferably from 200 to 400 m²/g, and more preferably from 250 to 350 m²/g.

Also, from the standpoint of the spin performance of the ball and the light-quenching properties, the delustering particles have an average primary particle size of preferably from 1.0 to 3.0 μm, and more preferably from 2.0 to 2.8 μm. When this value exceeds 3.0 μm, the ball surface becomes rough, which has an adverse effect on the spin performance and may even lower the performance. On the other hand, when this value is too small, the light-quenching effect may diminish.

The content of such delustering particles per 100 parts by weight of the base resin (combined amount of resin ingredients and solvent) in the coating layer-forming paint composition may be set to preferably from 5 to 10 parts by weight. When this content is too high, the viscosity of the paint composition rises and the painting operation tends to become more difficult to carry out. When it is too low, the light-quenching effect may diminish.

The coating layer has an average surface roughness Ra which, from the standpoint of both the spin rate of the ball on approach shots and the light-quenching properties, is preferably from 0.5 to 1.0. The surface roughness Ra of the paint film refers to the arithmetic average roughness as defined in JIS B0601 (1994).

The coating layer has a reflectance, as measured with a glossmeter, which is 5.0 or less at an angle of incidence of 20°, 20.0 or less at an angle of incidence of 60° and 40.0 or less at an angle of incidence of 85°. A coating layer that has been optimized so that the reflectance satisfies the foregoing ranges is able to impart a delustering effect. The conditions for measuring reflectance with a glossmeter include carrying out measurement with the instrument used in the subsequently described examples on an ABS resin plate that has been coated to a thickness of 20 μm.

Ball specifications such as the ball weight and diameter may be suitably set in accordance with the Rules of Golf.

### EXAMPLES

The following Working Examples and Comparative Examples are provided to illustrate the invention, and are not intended to limit the scope thereof.

### Working Examples 1 and 2, Comparative Examples 1 to 5

As shown in Table 1, the solid core in each Example was produced by using the following rubber composition, which is common to all the Examples, and vulcanizing for 15 minutes at 155° C.

TABLE 1

| Rubber composition for core | Common to all Working and |
|---|---|
| (parts by weight) | Comparative Examples |
| Polybutadiene rubber | 100 |
| Organic peroxide | 1 |
| Barium sulfate | 16 |
| Zinc oxide | 4 |
| Zinc acrylate | 30 |
| Zinc salt of pentachlorothiophenol | 0.3 |

Details on the above core materials are given below.
Polybutadiene: Available under the trade name “BR01” from JSR Corporation
Organic peroxide: Dicumyl peroxide, available as “Percumyl D” from NOF Corporation
Barium sulfate: Available from Sakai Chemical Co., Ltd.
Zinc oxide: Available from Sakai Chemical Co., Ltd.
Zinc acrylate: Available from Nippon Shokubai Co., Ltd.
Zinc salt of pentachlorothiophenol:
   Available from Wako Pure Chemical Industries, Ltd.

### Formation of Cover (Intermediate Layer and Outermost Layer)

Next, an intermediate layer-encased sphere having a diameter of 40 mm was produced by injection molding the intermediate layer-forming resin material shown in Table 2 below, which is common to all the Examples, to a thickness of 1.35 mm over the 37.3 mm diameter core obtained as described above. A three-piece golf ball having a ball diameter of 42.7 mm was then manufactured by injection-molding the outermost layer-forming material shown in the same table to a thickness of 1.35 mm over the intermediate layer-encased sphere. In each Example, a common dimple configuration was formed at this time on the surface of the outermost layer.

TABLE 2

| | | | Common to |
|---|---|---|---|
| Resin material | | | all Working and |
| (parts by weight) | | | Comparative Examples |
| Cover | Intermediate layer | HPF 1000 | 100 |
| | Outermost layer | Himilan 1601 | 50 |
| | | Himilan 1557 | 50 |
| | | Magnesium stearate | 1 |
| | | Titanium oxide | 2.8 |

Details on the materials in the table are given below.
HPF 1000: An ionomeric resin material available from E.I. DuPont de Nemours and Company
Himilan 1605, Himilan 1557: Ionomeric resins from DuPont-Mitsui Polychemicals Co., Ltd.
Titanium oxide: A white pigment

Next, using the two-part curable urethane paint made of a base resin and a curing agent shown in Table 3 below, the surface of the outermost layer of the golf ball in each Working Example and Comparative Example was coated to a thickness of 15 μm, thereby forming a coating layer. Delustering particles of differing particle sizes and specific surface areas were included in specific amounts with respect to the coating layer base resin (combined amount of resin ingredients and solvent) for the respective Working Examples and Comparative Examples. However, delustering particles were not included in Comparative Example 5.

TABLE 3

| | | Common to all Working and |
|---|---|---|
| Resin composition of paint (pbw) | | Comparative Examples |
| Base resin | Saturated polyester | 27.5 |
| | polyol (m.w., 28,000) | |
| | Solvent | 72.5 |
| | (Combined amount of | (100) |
| | resin ingredients and | |
| | solvent) | |
| | Delustering particles (silica) | Amount shown in Table 5 |
| | | for respective Examples |
| Curing agent | HMDI isocyanurate | 42 |
| | (low-molecular-weight) | |
| | Solvent | 58 |

Details on the base resin and curing agent are given in (i) to (iv) below.
(i) First, a reactor equipped with a reflux condenser, a dropping funnel, a gas inlet and a thermometer was charged with 140 parts by weight of trimethylolpropane, 95 parts by weight of ethylene glycol, 157 parts by weight of adipic acid and 58 parts by weight of 1,4-cyclohexanedimethanol, following which the temperature was raised to between 200 and 240° C. under stirring and the reaction was effected by 5 hours of heating. This yielded a saturated polyester polyol having an acid value of 4, a hydroxyl value of 170 and a weight-average molecular weight (Mw) of 28,000.
(ii) Next, the polyester polyol synthesized above was dissolved in butyl acetate, thereby preparing a varnish having a nonvolatiles content of 70 wt %.
(iii) The saturated polyester polyol (27.5 parts by weight) was dissolved with the butyl acetate (the nonvolatiles content of this solution was 27.5 wt %), and delustering particles of differing particle sizes and specific surface areas (as shown in Table 4) were included in specific amounts as the delustering particles.

TABLE 4

| Type of delustering | | | | | | |
|---|---|---|---|---|---|---|
| particle (silica) | P-1 | P-2 | P-3 | P-4 | P-5 | P-6 |
| Average primary | 2.4 | 2.7 | 3.7 | 2.7 | 2.8 | 9.5 |
| particle size (μm) | | | | | | |
| BET specific surface | 262 | 300 | 300 | 500 | 700 | 250 |
| area (mm²/g) | | | | | | |

P-1: “Finesil X-35” available from Maruo Calcium Co., Ltd.
P-2 to P-6: The ACEMATT ® series from Evonik Industries

(iv) Next, the isocyanate shown in Table 3 was dissolved in an organic solvent and used as the curing agent. That is, HMDI isocyanurate (available as Duranate™ TPA-100 from Asahi Kasei Corporation; NCO content, 23.1 wt %; nonvolatiles content, 100 wt %) and, as organic solvents, ethyl acetate and butyl acetate were added in the proportions shown in Table 3, thereby preparing a resin composition for use as a paint.

The spin rate on approach shots, glossiness and surface roughness (Ra) of the golf balls thus obtained in the respective Working Examples and Comparative Examples were measured and evaluated. The results are shown in Table 5 below.

### Spin Rate on Approach Shots

The golf balls obtained in the respective Working Examples and Comparative Examples were tested by mounting a sand wedge (SW) on a golf swing robot and measuring the amount of spin by the ball when struck at a head speed of 20 m/s. The club used was the TourB XW-1 SW manufactured by Bridgestone Sports Co., Ltd. The spin rates are shown in Table 5.

### Glossiness

The glossiness of the golf ball surface (coating layer) was evaluated as follows. The degrees of gloss at angles of incidence of 20°/60°/85° were measured with the BYK Micro-TRI-Gloss Meter. When the numerical values for degree of gloss at the respective measurement angles were 5.0 or less at an angle of incidence of 20°, 20.0 or less at an angle of incidence of 60° and 40.0 or less at an angle of incidence of 85°, the glossiness was sufficiently suppressed and thus rated as “Good.” Otherwise, the glossiness was rated as “NG.”

### Surface Roughness (Ra)

The surface roughnesses of golf balls having a coating layer were measured using a surface roughness tester (SV-C3000) from Mitutoyo Corporation. The surface roughness Ra of this paint film is based on the arithmetic average roughness defined in JIS B0601 (1994).

TABLE 5

| | | | | | Working | | | | | | |
|---|---|---|---|---|---|---|---|---|---|---|---|
| | | | | | Example | | Comparative Example | | | | |
| | | | | | 1 | 2 | 1 | 2 | 3 | 4 | 5 |
| Coating | Formulation | Base | Saturated polyester polyol | | 27.5 | 27.5 | 27.5 | 27.5 | 27.5 | 27.5 | 27.5 |
| layer | (pbw) | resin | (m.w., 28,000) | | | | | | | | |
| | | | Solvent | | 72.5 | 72.5 | 72.5 | 72.5 | 72.5 | 72.5 | 72.5 |
| | | | Combined amount | | 100 | 100 | 100 | 100 | 100 | 100 | 100 |
| | | | (resin ingredients + solvent) | | | | | | | | |
| | | | Delustering | Type | P-1 | P-2 | P-3 | P-4 | P-5 | P-6 | — |
| | | | particles | Amount | 9 | 9 | 6 | 9 | 9 | 5 | — |
| | | | (silica) | | | | | | | | |
| | | Curing | HMDI isocyanurate | | 42 | 42 | 42 | 42 | 42 | 42 | 42 |
| | | agent | (low-molecular-weight) | | | | | | | | |
| | | | Solvent | | 58 | 58 | 58 | 58 | 58 | 58 | 58 |
| | Physical | | Glossiness | Glossmeter | 1.2 | 1.2 | 1.2 | 3.5 | 40.7 | 1.2 | 60.0 |
| | properties | | | incident angle, 20° | | | | | | | |
| | | | | Glossmeter | 2.1 | 2.2 | 2.1 | 24.7 | 79.3 | 2.2 | 80.0 |
| | | | | incident angle, 60° | | | | | | | |
| | | | | Glossmeter | 9.3 | 16.9 | 3.2 | 72.1 | 94.8 | 7.5 | 97.0 |
| | | | | incident angle, 85° | | | | | | | |
| | | | | Rating | Good | Good | Good | NG | NG | Good | NG |

| | | | | | | | |
|---|---|---|---|---|---|---|---|
| Surface roughness (Ra) | 0.74 | 0.54 | 1.56 | 0.48 | 0.03 | 2.03 | 0.03 |

| | | | | | | | |
|---|---|---|---|---|---|---|---|
| Spin rate of ball on approach shots (rpm) | 2,850 | 2,850 | 2,800 | 2,850 | 2,900 | 2,750 | 2,900 |

The results in Table 5 show that the golf balls obtained in Working Examples 1 and 2 according to the invention had a high spin rate on approach shots, in addition to which the coating layer had a low glossiness, indicating a high delustering effect.

By contrast, in the golf balls of Comparative Examples 1 and 4, the coating layer had a low glossiness, indicating a high delustering effect, but the spin rate on approach shots was lower than in Working Examples 1 and 2.

The golf balls in Comparative Examples 2, 3 and 5 had a high spin rate on approach shots, but the coating layer had a high glossiness.

Japanese Patent Application No. 2018-124373 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core of at least one layer, wherein the golf ball has on a surface thereof a delustering particle-containing coating layer, which coating layer has an average surface roughness Ra of between 0.5 and 1.0.

2. The golf ball of claim 1, wherein the delustering particles have a BET specific surface area of from 200 to 400 m²/g.

3. The golf ball of claim 1, wherein the delustering particles have an average primary particle size of from 1.0 to 3.0 μm.

4. The golf ball of claim 1, wherein the content of delustering particles per 100 parts by weight of the coating layer base resin (combined amount of resin ingredients and solvent) is from 5 to 10 parts by weight.

5. The golf ball of claim 1, wherein the coating layer has a reflectance as measured with a glossmeter of 5.0 or less at an angle of incidence of 20°, 20.0 or less at an angle of incidence of 60°, and 40.0 or less at an angle of incidence of 85°.
